(19) United States
(12) Patent Application Publication
(10) Pub. No.: US 2015/0360606 A1
(43) Pub. Date: Dec. 17, 2015

(54) THIN FLEXIBLE LED LIGHT SHEET APPLICATIONS

(71) Applicant: Nthdegree Technologies Worldwide Inc., Tempe, AZ (US)

(72) Inventors: Travis Thompson, Chandler, AZ (US); Bradley S. Oraw, Chandler, AZ (US); Alexander Ray, Tempe, AZ (US); Andrew Dennis, Gilbert, AZ (US); Mark D. Lowenthal, Gilbert, AZ (US); Sara Behm, Chandler, AZ (US); William J. Ray, Fountain Hills, AZ (US); Richard A. Blanchard, Los Altos, CA (US); Neil O. Shotton, Tempe, AZ (US)

(21) Appl. No.: 14/303,410

(22) Filed: Jun. 12, 2014

(51) Int. Cl. B60Q 3/02; B60Q 3/06

(52) U.S. Cl. CPC B60Q 3/0283; B60Q 3/0203; B60Q 3/0293; B60Q 3/06; B60Q 3/0216; B60Q 3/0226; B60Q 3/0223; B60Q 3/0243

(57) ABSTRACT

Various applications and customizations of a thin flexible LED light sheet are described. Microscopic LED dice are printed on a thin substrate, and the LEDs are sandwiched between two conductor layers to connect the LEDs in parallel. The conductor layer on the light emitting side is transparent. In one embodiment, the light sheet backlights all or a portion of a translucent ceiling material of an automobile to cause the backlit portion of the ceiling material to illuminate the automobile's interior with diffused lighting. This greatly reduces glare for the driver. The emitted color of the light sheet may be adjusted to compensate for the color component added by the ceiling material color. Four light sheets may be connected in series to drop approximately 12 volts. The light sheet color may be controllable by using adjustable RGB color components, either with phosphors or different LED colors.

### FIELD OF THE INVENTION

This invention relates to various applications for a thin, flexible light emitting diode (LED) light sheet.

### BACKGROUND

The present assignee has previously invented a flat light sheet formed by printing microscopic vertical LED dice over a conductor layer on a flexible substrate to electrically contact the LED's bottom electrodes, then printing a thin dielectric layer over the conductor layer which exposes the LED's top electrodes, then printing another conductor layer to contact the LED's top electrodes.

The LEDs may be printed to have a large percentage of the LEDs with the same orientation so the light sheet may be driven with a DC voltage, or the LEDs may be printed so that approximately one-half of the LEDs have one orientation and the other half has the opposite orientation so an AC signal can drive all the LEDs. In either case, a large number of the LEDs dice are connected in parallel.

By using a transparent film as the substrate and making either or both of the conductor layers transparent, light may exit through either surface or both surfaces simultaneously. If the LEDs are GaN-based and emit blue light, a phosphor layer (e.g., YAG) may be deposited over the light emitting surface to cause the light sheet to emit any color light, such as white light. The light sheets may be formed to have a thickness between about 5-13 mils (125-325 microns), including the phosphor layer.

Further detail of forming a light source by printing microscopic vertical LEDs, and controlling their orientation on a substrate, can be found in US application publication US 2012/0164796, titled, Method of Manufacturing a Printable Composition of Liquid or Gel Suspension of Diodes, assigned to the present assignee and incorporated herein by reference.

### SUMMARY

This present disclosure describes various applications of a thin, flexible LED light sheet, where the basic light sheet fabrication technology is disclosed in US 2012/0164796, but where the light sheet itself is customized for each particular application described herein.

In the various applications described herein, the light sheet has a variety of shapes and novel features. The long life of the light sheet, as a result of the long life of LEDs, enables the light sheet to be permanently incorporated in a wide variety of devices.

Some applications of the LED light sheet, customized for the particular application, include:
Automobile interior and exterior lighting;
Backlighting keyboards, keypads, graphics, signs, etc.;
Attraction-getting displays for packaging;
Integrating the light sheet into consumer devices for controls, logos, etc.;
Self-powered disposable lighting units and safety strips with integrated photovoltaic devices and batteries;
Reading lights and other directed lights;
Illuminating the ends of medical devices such as dental devices and endoscopes;
Lining interior walls with flat light sheets;
Illumination under or above shelves;
Modular light sheet sections that interconnect together;
Laminating the light sheet over clothing and shoes for safety and ornamentation;
Using UV LEDs in the light sheet for sanitization;
Creating controllable colors;
Forming light strips as an adhesive tape;
Unrolling light sheets to create portable signs, safety cones, etc.;
Lighting walkways and providing guide paths;
Reflective displays that use either the sun or an LED sheet as the light source;
Color or monochrome addressable displays having printed LEDs in pixel areas;
Light or image sensors having printed photodiodes;
Visual entertainment systems; and
Bending or molding the light sheet to achieve desired light emission characteristics;

Many other applications are contemplated and described.

### BRIEF DESCRIPTION OF THE DRAWINGS

FIG. 1 is a cross-section of a thin, flexible light sheet that has been shaped or otherwise customized for some of the applications described herein. Variations of the light sheet of FIG. 1 are employed depending on the particular application.

FIG. 2 is a top down view of the structure of FIG. 1, where FIG. 1 is taken along line 1-1 in FIG. 2.

FIG. 3 illustrates a shaped light sheet or printed area of LEDs used as a logo or other symbol.

FIG. 4 illustrates an automobile containing customized light sheets for various functions.

FIG. 5 is a cross-sectional view of the light sheet installed behind the automobile's mesh ceiling material for diffused ambient lighting.

FIG. 6 illustrates an automobile visor containing a light sheet.

FIG. 7 illustrates a steering wheel containing a light sheet for backlighting various features.

FIG. 8 illustrates an automobile front seat containing light sheets.

FIG. 9 illustrates a light sheet incorporated into a seat belt receptacle.

FIG. 10 illustrates a light sheet lining the interior walls of a glove box.

FIG. 11 illustrates a light sheet backlighting a console of an automobile.

FIG. 12 illustrates a light sheet backlighting a keyboard.

FIG. 13 illustrates a light sheet backlighting a touch sensor.

FIG. 14 is a cross-sectional view of side-emitting LEDs, as part of a light sheet, whose light is mixed in a mixing chamber to uniformly backlight graphics.

FIG. 15 is a cross-sectional view of a folded light sheet for mixing light to create a more uniform emission, such as for backlighting.

FIG. 16 illustrates a light sheet as part of packaging or an insert for a package to attract potential consumers to the product.

FIG. 17 illustrates a light sheet forming a logo for the product itself, rather than its package, where the logo may be directly formed by the light sheet or backlit by the light sheet.

FIG. 18 illustrates a self-powered disposable light sheet.

FIG. 19 illustrates a light strip affixed to glasses.

FIG. 20 is a cross-section of an edge-emitting light sheet surrounding a fiber optic cable for an endoscope or other device.

FIG. 21 illustrates an endoscope employing the edge-emitting light sheet of FIG. 20.

FIG. 22 illustrates the edge-emitting light sheet attached to the end of a dental tool.

FIG. 23 illustrates a refrigerator or a cabinet using light sheets on its walls or shelves to illuminate its interior.

FIG. 24 illustrates a light strip applied to the edge of a light-guiding shelf to illuminate objects on the shelf.

FIG. 25 illustrates how a light sheet may be temporarily unrolled for use, then rolled up for compactness.

FIG. 26 illustrates how a light strip may be used to illuminate a photograph in a frame.

FIG. 27 illustrates how a light strip may be used to illuminate the fronts of objects on a shelf.

FIG. 28 illustrates how multiple light sheets may be physically and electrically connected together.

FIG. 29 is a cross-section of two light sheets being electrically connected together, where an attractive force is provided by magnets.

FIG. 30 illustrates a glove having light sheets at tips of the fingers and thumb for illuminating objects being handled.

FIG. 31 illustrates a shoe insert comprising a light sheet containing UV LEDs for killing bacteria.

FIG. 32 illustrates a shoe having a light sheet at its tip for illuminating an area in front of the shoe.

FIG. 33 illustrates a light sheet provided on an article of clothing for safety and/or illumination.

FIG. 34 illustrates a self-powered light sheet containing a photovoltaic cell and a rechargeable battery.

FIG. 35 is a cross-section of one type of reflective display that uses either the sun or LEDs as the light source.

FIG. 36 is a cross-section of another type of reflective display the uses either the sun or LEDs as the light source, where the LEDs are provided along the edges of the display.

FIG. 37 illustrates an addressable display where LEDs are printed in pixel areas.

FIG. 38 illustrates a color pixel in an addressable display, where LEDs are printed in sub-pixel areas for providing controllable red, green, and blue wavelengths.

FIG. 39 is a cross-section of a color pixel comprising layers of red, green, and blue LEDs.

FIG. 40 illustrates how very thin LED display panels may be interconnected for customizing the size of a display screen.

FIG. 41 illustrates an image or light sensor containing an array of printed photodiodes instead of LEDs.

FIG. 42 illustrates a speaker with a light sheet affixed to the moving cone of the speaker and controlled by a piezoelectric element for creating lighting effects.

FIGS. 43A and 43B illustrate a device that changes color over time using a light sheet as the central light source and phosphor particles in a liquid surrounding the light source.

Elements that are similar or identical in the various figures are labeled with the same numeral.

### DETAILED DESCRIPTION

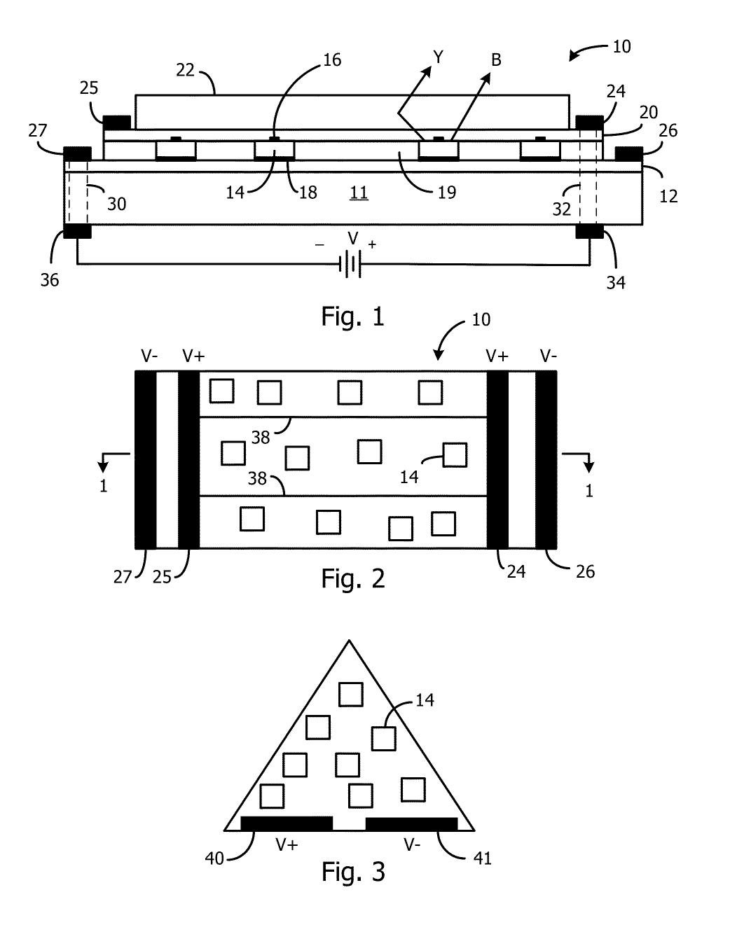

In one embodiment of the invention, a highly flexible and thin light sheet containing microscopic LED dice is customized for a particular application. The light sheet may have a thickness between 5-13 mils, including a phosphor layer, which is on the order of the thickness of a sheet of paper or cloth. FIGS. 1 and 2 illustrate a light sheet 10 that may form part of the light sheet employed in any of the applications described herein. The shape of the light sheet 10, the pattern of printed LEDs, and certain features are customized for the particular application.

In FIG. 1, a starting substrate 11 may be polycarbonate, PET (polyester), PMMA, Mylar or other type of polymer sheet, or even a thin metal film, paper, cloth, or other material. In one embodiment, the substrate 11 is about 25-50 microns thick.

A conductor layer 12 is then deposited over the substrate 11, such as by printing. The substrate 11 and/or conductor layer 12 may be reflective if the light from the LEDs is to only be emitted from the opposite side. For example, the conductor layer 12 may be a printed aluminum layer or a laminated aluminum film. Alternatively, a reflective layer may be first laminated over the substrate 11 followed by printing a transparent conductor layer 12 over the reflective film. A reflective film, including a white diffusing paint, may also be provided on the back surface of the substrate 11. A suitable transparent conductor layer 12 may be a silver nano-wire layer since such a layer is highly flexible.

A monolayer of microscopic inorganic LEDs 14 is then printed over the conductor layer 12. The LEDs 14 are vertical LEDs and include standard semiconductor GaN layers, including an n-layer, and active layer, and a p-layer. GaN LEDs typically emit blue light. The LEDs 14, however, may be any type of LED emitting red, green, yellow, or other color light.

The GaN-based micro-LEDs used in embodiments of the present invention are less than a third the diameter of a human hair and less than a tenth as high, rendering them essentially invisible to the naked eye when the LEDs are sparsely spread across the substrate 11 to be illuminated. This attribute permits construction of a nearly or partially transparent light-generating layer made with micro-LEDs. In one embodiment, the LEDs 14 have a diameter less than 50 microns and a height less than 10 microns. The number of micro-LED devices per unit area may be freely adjusted when applying the micro-LEDs to the substrate 11. A well dispersed random distribution across the surface can produce nearly any desirable surface brightness. Lamps well in excess of 10,000 cd/m² have been demonstrated by the assignee. The LEDs may be printed as an ink using screen printing or other forms of printing. Further detail of forming a light source by printing microscopic vertical LEDs, and controlling their orientation on a substrate, can be found in US application publication US 2012/0164796, entitled, Method of Manufacturing a Printable Composition of Liquid or Gel Suspension of Diodes, assigned to the present assignee and incorporated herein by reference.

In one embodiment, an LED wafer, containing many thousands of vertical LEDs, is fabricated so that the top metal electrode 16 for each LED is small to allow light to exit the top surface of the LEDs. The bottom metal electrode 18 is reflective (a mirror) and should have a reflectivity of over 90% for visible light. There is some side light, depending on the thickness of the LED. In the example, the anode electrode is on top and the cathode electrode is on the bottom. In other embodiments, the top electrode may cover the entire surface of the LED and is reflective, and light exits the bottom of the LED through a transparent conductor layer 12 and a transparent substrate 11. In another embodiment, the electrodes are formed so that light exits both surfaces, and the lamp emits light though both surfaces of the light sheet.

The LEDs are completely formed on the wafer, including the anode and cathode metallizations, by using one or more carrier wafers during the processing and removing the growth substrate to gain access to both LED surfaces for metallization. The LED wafer is bonded to the carrier wafer using a dissolvable bonding adhesive. After the LEDs are formed on the wafer, trenches are photolithographically defined and etched in the front surface of the wafer around each LED, to a depth equal to the bottom electrode, so that each LED has a diameter of less than 50 microns and a thickness of about 4-8 microns, making them essentially invisible to the naked eye. A preferred shape of each LED is hexagonal. The trench etch exposes the underlying wafer bonding adhesive. The bonding adhesive is then dissolved in a solution to release the LEDs from the carrier wafer. Singulation may instead be performed by thinning the back surface of the wafer until the LEDs are singulated. The LEDs 14 of FIG. 1 result, depending on the metallization designs. The microscopic LEDs 14 are then uniformly infused in a solvent, including a viscosity-modifying polymer resin, to form an LED ink for printing, such as screen printing, or flexographic printing.

The LEDs 14 may instead be formed using many other techniques and may be much larger or smaller. The lamps described herein may be constructed by techniques other than printing.

The LED ink is then printed over the conductor layer 12. The orientation of the LEDs 14 can be controlled by providing a relatively tall top electrode 16 (e.g., the anode electrode), so that the top electrode 16 orients upward by taking the fluid path of least resistance through the solvent after printing. The anode and cathode surfaces may be opposite to those shown. The LED ink is heated (cured) to evaporate the solvent. After curing, the LEDs remain attached to the underlying conductor layer 12 with a small amount of residual resin that was dissolved in the LED ink as a viscosity modifier. The adhesive properties of the resin and the decrease in volume of resin underneath the LEDs 14 during curing press the bottom cathode electrode 18 against the underlying conductor layer 12, creating a good electrical connection. Over 90% like orientation has been achieved, although satisfactory performance may be achieved with over 75% of the LEDs being in the same orientation.

A dielectric layer 19 is then selectively printed over the conductor layer 12 to encapsulate the sides of the LEDs 14 and further secure them in position. The ink used in the dielectric layer 19 pulls back from the upper surface of the LEDs 14, or de-wets from the top of the LEDs 14, during curing to expose the top electrodes 16. If any dielectric remains over the LEDs 14, a blanket etch step may be performed to expose the top electrodes 16.

A transparent conductor layer 20 is then printed to contact the top electrodes 16. The conductor layer 20 may be ITO or may include silver nano-wires. The conductor layer 20 is cured by lamps to create good electrical contact to the electrodes 16. Since ITO is relatively brittle, it is preferred to use a cured silver nano-wire solution to form the transparent conductor layer 20. The curing sinters overlapping silver nano-wires together to form a flexible 3-dimensional mesh of wires have large openings for allowing light to pass through.

The LEDs 14 in the monolayer, within a defined area, are connected in parallel by the conductor layers 12/20 since the LEDs 14 have the same orientation. Since the LEDs 14 are connected in parallel, the driving voltage must approximately equal the voltage drop of a single LED 14.

Many other ways can be used to form the LEDs 14, and the LEDs 14 do not need to be microscopic or printed for the present invention to apply.

A flexible, protective layer (not shown) may be printed over the transparent conductor layer 20. If wavelength conversion is desired, a phosphor layer 22 may be printed over the surface. The phosphor layer may comprise phosphor powder (e.g. a YAG phosphor) in a transparent flexible binder, such as a resin or silicone. In one embodiment, the phosphor layer 22 is conductive, such as by containing sintered nano-wires, so a separate transparent conductor layer 20 is optional, and electrical access to the LEDs is made easier by just contacting the phosphor layer. In another embodiment, the layer 22 may represent a diffuser layer to eliminate any perceived sparkle from the microscopic LEDs. A phosphor layer also acts as a diffuser.

The flexible light sheet 10 of FIG. 1 may be any size and may even be a continuous sheet formed during a roll-to-roll process that is later stamped out for a particular application.

FIGS. 1 and 2 also illustrate how the thin conductor layers 12 and 20 on the light sheet 10 may be electrically contacted along their edges by metal bus bars 24-27 that are printed and cured to electrically contact the conductor layers 12 and 20. The metal bus bars along opposite edges are shorted together by a printed metal portion outside of the cross-section. The structure may have one or more conductive vias 30 and 32 (metal filled through-holes), which form a bottom anode lead 34 and a bottom cathode lead 36 so that all electrical connections may be made from the bottom of the substrate 11. Instead of vias, the top metal may be connected to the bottom metal by other means, such as metal straps extending over the edges of the light sheet. A suitable voltage differential applied to the leads 34 and 36 turns on the LEDs 14 to emit light through one or both surfaces of the light sheet 10.

FIG. 2 is a top down view of the light sheet 10 of FIG. 1, where FIG. 1 is taken along line 1-1 in FIG. 2. If the light sheet 10 is wide, there will be a significant IR drop across at least the transparent conductor layer 20. Thin metal runners 38 may be printed along the surface of the conductor layer 20 between the opposing bus bars 24 and 25 to cause the conductor layer 20 to have a more uniform voltage, resulting in more uniform current spreading. In an actual embodiment, there may be thousands of LEDs 14 in a light sheet 10.

FIG. 3 illustrates how the light sheet or the printed pattern of LEDs 14 may be made into any arbitrary shape, such as a product's logo, with metal leads 40 and 41 for receiving a driving voltage.

To show the wide range of uses of the basic light sheet 10 structure, the various figures are grouped into categories, including automobile applications, backlighting applications, packaging applications, illumination of objects applications, interconnection features, clothing and textile applications, safety applications, addressable display applications, and entertainment applications. Additional embodiments and applications are described herein.

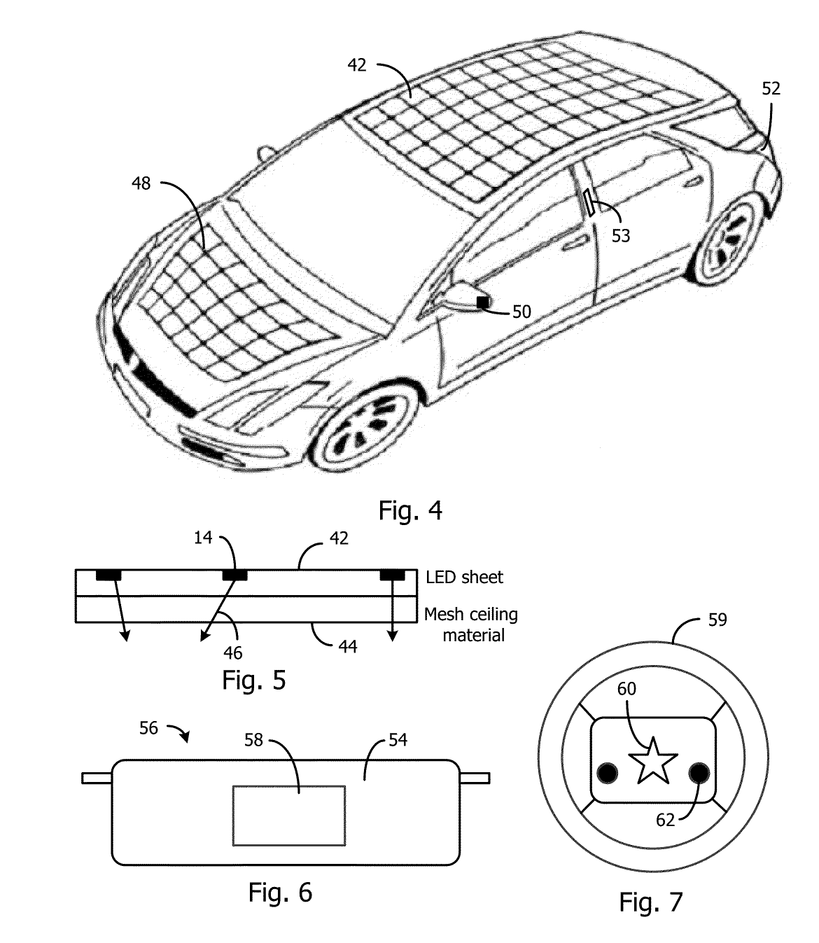

FIG. 4 is a perspective view of an automobile using the LED light sheet for various functions.

For a diffused ambient light that is not distracting to the driver, a wide area LED light sheet 42 is provided in the interior of the automobile behind the conventional translucent ceiling material. In such a case, the light sheet 42 cannot be seen through the ceiling material in the off-state. Since the light is spread out, there is no glare for the driver. This technique obviates the need for a central overhead bright light bulb in the ceiling, which is generally distracting to the driver, creates shadows, and requires a reflective housing.

FIG. 5 is a cross-sectional view of a portion of the light sheet 42 behind a typical translucent automobile ceiling material 44, where the light rays 46 pass through and become diffused by the ceiling material 44. Ceiling material for an automobile is typically a thin sheet of polyester and is typically woven or has an array of pin holes punched through it. In either case, the openings in the weave or the holes allow the LED backlight to directly pass through, and the polyester material itself is typically translucent, so light from the light sheet 42 effectively illuminates the entire backlit ceiling of the automobile. The weave or hole density may be selected to allow a desired amount of light to pass directly through the openings in the material.

A phosphor layer on the light sheet 42, or the LED color itself, may be adjusted to offset any color component added by the ceiling material so the diffused light appears white or has substantially the desired target color temperature. This may be done by selecting the phosphor type(s) and/or the density and thickness of the phosphor. Multiple color LEDs may be used in the light sheet, and the RGB components can be individually controlled, to allow the resulting color to either achieve a target color temperature or to allow the user to select the illumination color. Controlling the color of a light sheet is also described with respect to FIGS. 38 and 39, and such a technique may be used for the light sheet 42.

Any standard sound/temperature insulating material may be inserted behind the light sheet 42. Typically, there will be an air gap between the ceiling material and the light sheet 42 so the characteristics of the ceiling material are unaffected. This illumination technique may be employed with little or no change to the existing interior of the automobile. In another embodiment, the light sheet 42 is laminated to the back of the ceiling material 44 prior to the ceiling material 44 being installed in the automobile.

In one embodiment, the light sheet 42 backlights over 75% of the ceiling material 44. In another embodiment, the light sheet 42 backlights over 50% of the ceiling material 44.

In one embodiment, the light sheet 42, or multiple light sheets, overlie the rear passenger area, the front passenger area, and the driver area. The light sheet(s) over each area is separately controllable by switches so that only the person that desires the light is illuminated by the overhead light.

In one embodiment, the color of the light sheet(s) may be controlled by using different phosphor areas or different colors of LEDs, as described above, and the color of the light may be controlled by the driver or passenger depending on the particular use of the light. For example, for driving at night, a passenger may want the illumination to be redder to minimize interference with the driver's vision. If the passenger wanted a brighter light for reading, the passenger would control the emission color to add green and blue components to create a whiter light.

In another embodiment, the light from the light sheet 42 is dimmable by use of an appropriate PWM controller.

This same technique can be used to illuminate any vehicle, such as vans, trucks, etc., or any other structure that uses a thin translucent ceiling material.

To avoid the use of any power converter, multiple light sheets, such as four, can be connected in series to achieve a voltage drop of approximately 12 volts, which is a typical automobile battery voltage. The ceiling light may automatically turn on when a door is opened, or can be manually controlled. In one embodiment, the light sheet 42 does not extend forward of the driver's eyes so as not to interfere with the driver's vision at night. The light sheet 42 may cover anywhere up to 100% of the ceiling area. Since the light sheet 42 is extremely thin and flexible, no other modifications need to be made to the automobile to add the light sheet feature.

An additional light sheet 48 may be installed in the hood (to illuminate the engine) and in the trunk, which is energized when the hood or trunk is opened. The broad area light provides better illumination that the conventional bulbs mounted on hoods and trunks.

The light sheet may be formed to have a high brightness per unit area so can be used as turn signals on the side mirrors (light sheet 50) and as a rear or front wrap-around light 52 of any color for use as a stop light, a turn signal, a reverse light, a daytime running light, etc. A light sheet may also illuminate the license plate or form a logo of the automobile. The light sheets may be adhesively applied to the exterior of the automobile or provided behind a transparent window.

The floor or the area around the floor may also be illuminated with light sheets.

Unlike a bulb, the light sheets do not need a robust electrical receptacle, or a reflector, or a protective housing. Therefore, there is minimal impact on the automobile design to accommodate any number of the light sheets. Further, the life of an LED typically outlasts the life of the automobile, so the light sheets may be permanently installed.

LED strips may also be affixed to the bottom edge of each door and automatically illuminated when the door is opened to uniformly illuminate the stepping area around the automobile. These types of lights are sometimes referred to as puddle lights. LED light strips may also be affixed to the running boards, or sills, opposing the bottom of the doors.

The inside and outside door handles may also be formed to include LED light strips to show the handles at night. The colors of the light strips may be controlled to indicate whether the car is locked or unlocked. The light sheets may be used to backlight any translucent portion of the automobile.

An LED light sheet may also backlight a keyless entry touch pad 53 located on the column between the doors.

The LED light sheet may also illuminate the inside of a cup holder and the gear shift area, or any other object that is to be illuminated at night. Power may be applied when the driver turns on the headlights.

FIG. 6 illustrates how a light sheet 54 forms the front of an automobile's flip-down visor 56. The LEDs are illuminated automatically when the visor 56 is flipped down. A center mirror 58 is also shown.

For safety reasons, the hub of the steering wheel should be soft. In modern cars, the steering wheel contains various controls, such as speed controls, audio controls, and horn controls. FIG. 7 illustrates a steering wheel 59 with a center hub containing controls that are backlit by the flexible LED light sheet. The car's logo 60 is dimly lit and the horn buttons 62 are visible at night by backlighting from a single light sheet. Any other controls may be backlit from the same flexible light sheet, and the LEDs may only be printed in areas aligned with the items to be backlit to save power and reduce cost.

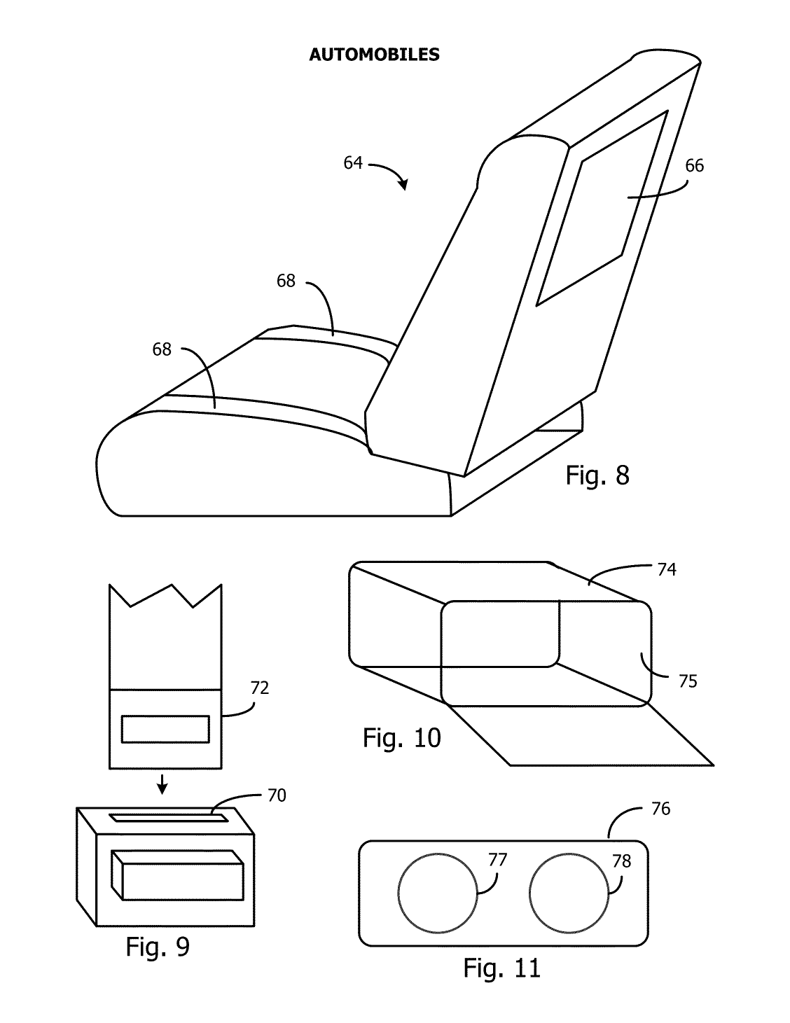

FIG. 8 illustrates how the back of the front seats 64 may have an LED light sheet 66 laminated to the back of it for use by the rear seat passengers. Unlike the harsh glaring light of a bulb, the light sheet 66 provides a highly diffused light at a fraction of the cost of the bulb lamp and has a reliability that allows the light sheet 66 to be permanently affixed to the seat 64.

FIG. 8 also shows LED light strips 68 on the seat itself. The thinness and flexibility of the light strips 68 allows this application.

FIG. 9 illustrates how a small LED light sheet may be incorporated in the seat belt receptacle 70 so the passenger knows where to insert the seat belt buckle 72 in the dark. Power is already applied to the receptacle 70 for detecting the insertion of the buckle 72 so there is no additional wiring needed to power the light sheet.

Since the light sheet is thin and flexible, it may cover the inner top and side walls of a glove box 74, shown in FIG. 10. Unlike conventional bulbs in glove boxes, the wide area light from the light sheet 75 is not blocked by objects in the glove box 74.

FIG. 11 illustrates how a single LED light sheet may backlight an entire console 76 of an automobile. A speedometer 77 and tachometer 78 are shown. Although LED are commonly used in automobiles in the same way bulbs were used, such LEDs are typically used to couple light to a lightguide, where the lightguide leaks the light in the direction of the driver. However, with the LED light sheet, the light is inherently diffused and directed forward, obviating the need for any lightguide. This characteristic creates many additional possibilities for lighting.

Backlighting for devices other than in automobiles is next described, using the basic light sheet structure of FIG. 1.

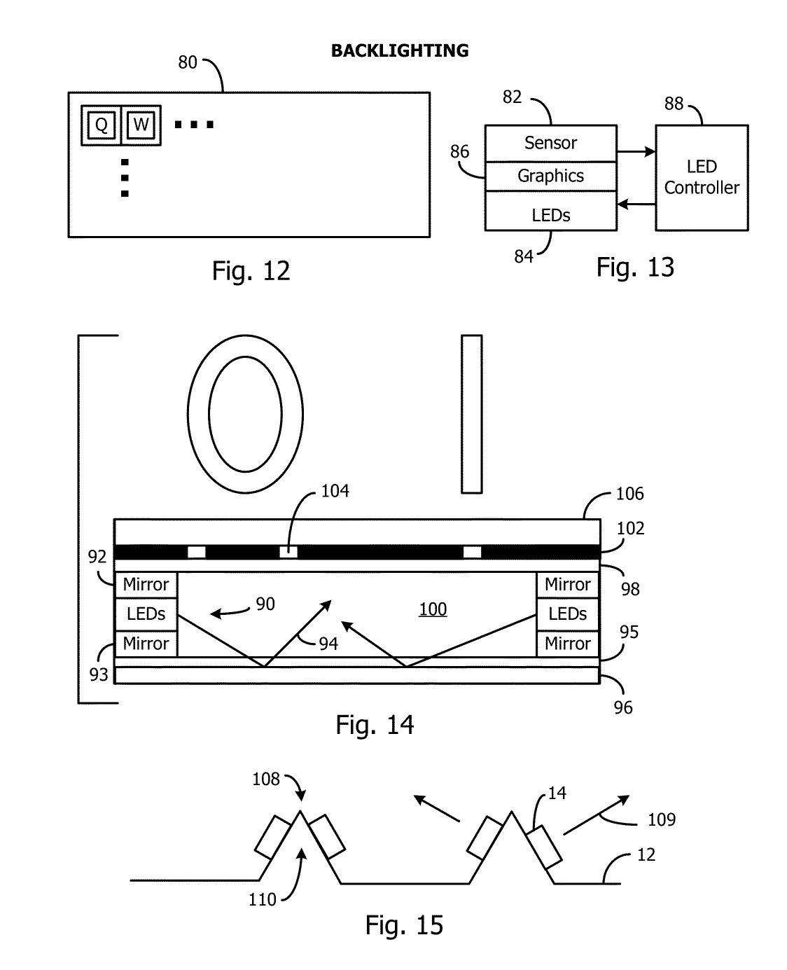

FIG. 12 illustrates the LED light sheet backlighting a conventional QWERTY keyboard 80. The LEDs may be printed in only those areas on the substrate 11 (FIG. 1) that are directly behind a character to be backlight to preserve power and cost. In the example, opaque graphics are molded into the keyboard and keys that define openings for the letters as well as an outline of the keys. Conventional backlit keyboards include lightguides that are more complex to incorporate as backlights.

FIG. 13 illustrates a transparent capacitive touch sensor layer 82 laminated over, or integrated with, an LED light sheet 84 to backlight a graphics layer 86. The graphics layer 86 may instead be over the sensor layer 82. The graphics layer 86 is an opaque layer having openings defining symbols, such as alphanumeric characters. There may be a diffusive layer over the graphics layer 86 so the user cannot see the graphics except when the device is backlit. When an LED controller 88 senses a touch or a finger proximate to the sensor layer 82, the LEDs are illuminated. This allows the keypad or other device to be essentially invisible until needed for aesthetic purposes. This is called a dead-front. The controller 88 may then serve as a conventional touch sensor controller for processing the keypad selections.

FIG. 14 is a cross-section of a small portion of a backlit display or keypad, which may include a touch sensor layer, such as shown in FIG. 12. The LEDs 90 are formed to have top and bottom metal mirror electrodes 92 and 93 so that all light 94 is emitted from the sides of the LEDs 90 toward the middle of the structure. The LEDs 90 are printed over a transparent conductor layer 95 having an underlying reflector layer 96. The LEDs 90 are only printed along the edges of the light sheet. The top electrodes of the LEDs 90 are electrically contacted by another transparent conductor layer 98. Between the opposing strips of LEDs 90 is a transparent dielectric layer 100. The reflector layer 96 and/or the surfaces of the dielectric layer 100 may be diffusive, such as obtained by roughening, so that the light is mixed within the dielectric layer 100 to create a uniform brightness along the top surface of the dielectric layer 100. A layer of opaque graphics 102, printed over the transparent conductor layer 98, has openings 104 which define symbols, such as alphanumeric characters. A reflective layer may be printed below the opaque portions to reduce light absorption. Therefore, a uniform brightness light is emitted through the openings 104. A top diffuser layer 106 further mixes the light and may be used to cause the graphics to be invisible until backlit. In the example, the numbers 0 and 1 are displayed by the structure, which may be part of a touch sensor keypad.

Alternatively, narrow strips of the LEDs are affixed around the edges of the structure and inject light in from the sides, in which case the LEDs are not side-emitting types.

FIG. 15 illustrates an alternative way of mixing light to create a uniform brightness emission for backlighting. A flat light sheet is formed, such as shown in FIG. 1, with printed LEDs 14 sandwiched between two conductor layers (only the bottom conductor layer 12 is shown in FIG. 15). The light sheet is then bent or molded to create parallel rows of angles 108 so the LEDs 14 primarily emit light 109 at shallow angles to mix the light within a spacer layer, which may be an air layer. The folds may be retained by an adhesive injected into the concave areas 110. Alternatively, a heated mold may permanently deform the light sheet layers. The structure may then be used to backlight a graphics layer, such as the graphics layer 102 of FIG. 14.

Packaging applications using the basic light sheet structure of FIG. 1 are next described.

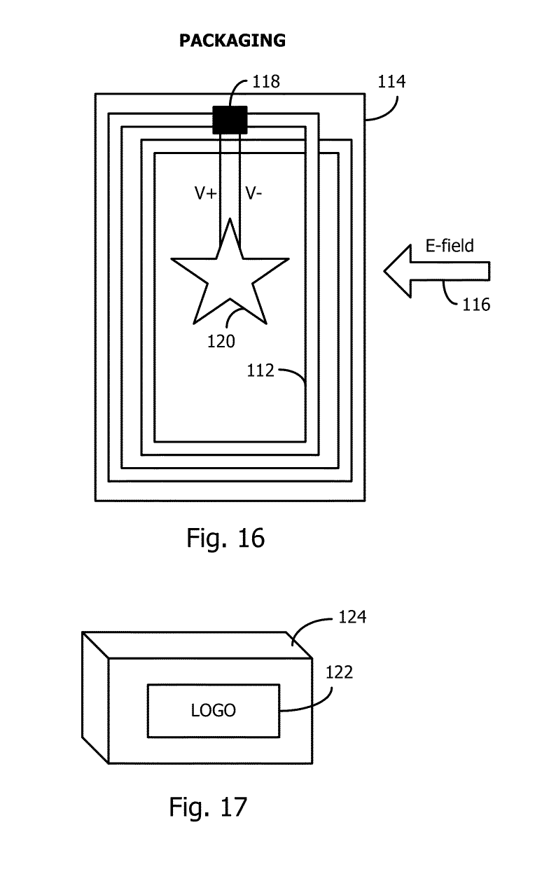

FIG. 16 illustrates a portion of the outer or inner surface of a package for containing a consumer product, such as a razor. Alternatively, FIG. 16 may illustrate an insert for a transparent package. All elements are printed. A spiral metal trace 112 is printed on an opaque or transparent thin flexible substrate 114. The trace 112 forms an inductor, and a constant or intermittent electromagnetic field 116 generated by the store's display case proximate to the package induces a current in the trace 112. A rectifier circuit 118 (an IC) converts the AC current generated by the trace 112 into a DC voltage, and the DC voltage is applied to the leads of a patterned LED layer 120 printed over the same substrate 114. In the example, the LEDs are printed in a star pattern, which may be a logo of the product. The circuit 118 may also include a current limiter. The LEDs may be the same as the LEDs 14 in FIG. 1, and the same printing step that formed the trace 112 may also form the bottom conductor layer for the LEDs. A transparent conductor layer forms the top conductor for the LEDs. The patterning may be by screen printing, flexography, or other technique. Thus, when the field 116 is generated, the LEDs forming the pattern are automatically illuminated to draw attention to the product, increasing sales. The circuit 118 may also include a state machine that controls segments of printed LEDs to create an animation inside or outside the package.

FIG. 17 generally depicts how the LEDs in the LED light sheet 122 may be printed to display any logo on the product 124 itself. The LED pattern may directly depict the logo, or the logo may be backlit by the LEDs. The light sheet 122 may be molded directly into the product, such as the outer plastic housing of an appliance, and possibly be protected by a transparent plastic window. Since LEDs have a very long lifetime and there is high redundancy in the LED light sheet (since thousands of LEDs may be connected in parallel), the light sheet may be a permanent and integral part of the product.

General illumination applications using the basic light sheet structure of FIG. 1 are next described.

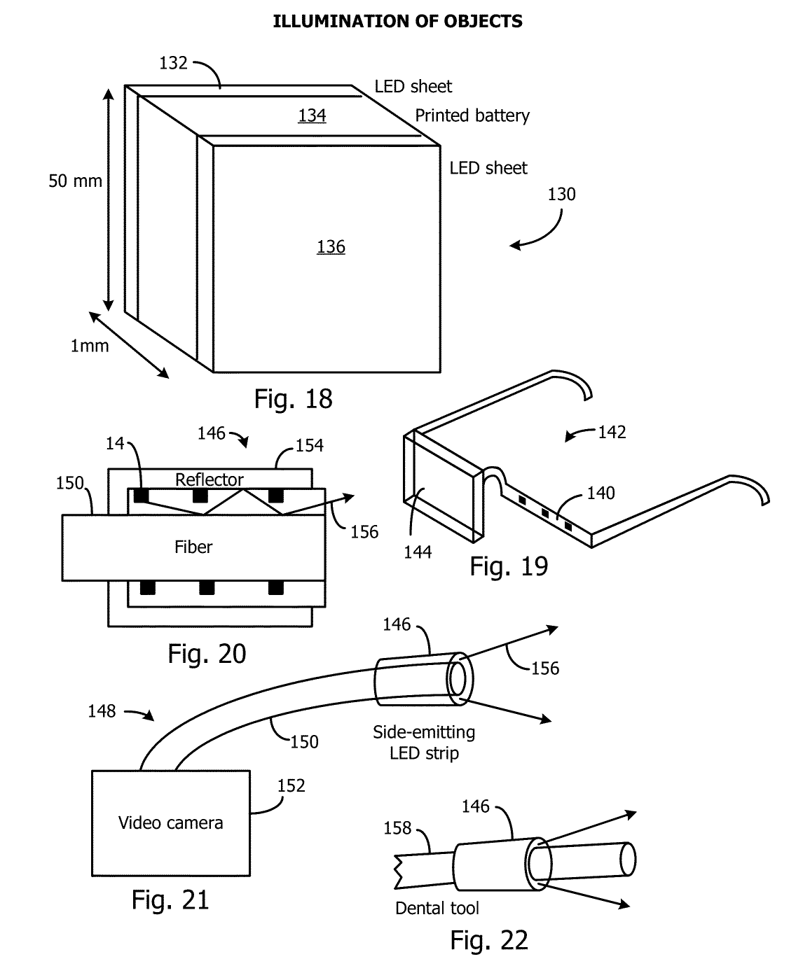

FIG. 18 illustrates a very inexpensive disposable lighting device 130 that may serve to substitute for disposable chemical glow-sticks, for example. Many such disposable devices 130 may be provided in a single package. The various layers may be laminated together or printed over the same substrate. In the example, the device 130 is relatively small, such as 50 mm per side and 1 mm thick, and is sold as a stack. The devices may be formed in large sheets and stamped out for singulation. A first LED light sheet 132 is formed over a transparent substrate. A lithium ion battery 134, or other type of known printable battery, is printed over the light sheet 132 or laminated over it. A second LED light sheet 136 is then printed over or laminated over the battery 134. The battery life may be anywhere from 15 minutes to 2 hours or more depending on the current drawn by the LEDs and the size of the battery. Various illumination times may be offered. A weak adhesive may be provided on the back of each device 130. Instead of two light sheets being used, only one light sheet may be used for a Lambertian emission. The electrical connections between the battery 134 and the light sheets may be side connectors, or conductive vias through the various layers may be used. By bending the device 130 or removing the device 130 from a dispenser, an electrical connection is made between the battery 134 and the light sheets 132/136 to illuminate the LEDs. In one embodiment, bending the device 130 causes two metal strips to connect together to initiate current flow through the LEDs. The device 130 is then disposed of after the battery 134 has been depleted.

In an alternative embodiment, a set of the devices 130 is provided in a package having a photovoltaic cell that keeps the batteries 134 of all the devices 130 constantly charged. When one of the devices 130 is removed from the pack, the battery 134 is electrically coupled to the LEDs to turn on the removed device 130.

FIG. 19 illustrates an LED light strip 140 affixed to the front of “smart” glasses 142, such as Google Glass™, to illuminate objects. The glasses 142 may be equipped with a video camera and forms a screen using the lens 144. The LEDs are automatically illuminated for adequate capture of images.

In some applications of the LED light sheet technology, the light must be emitted from the thin edges of the light sheet. FIG. 20 illustrates how a light sheet may emit primarily from its edge. In the example of FIG. 21, the light sheet 146 is the light source of an endoscope 148. A conventional endoscope, for insertion into a body cavity, includes a relatively thick central fiber optic cable for optically coupling an image to a remote video camera. In such a conventional endoscope, a relatively thick outer fiber optic layer, concentric with the video fiber, is coupled to a high brightness remote light source that couples light into one end of the fiber optic layer. The light exits the other end of the fiber to illuminate the area in front of the video fiber end to view the inside of the body cavity. It is desirable that the composite cable be thin and the light be bright despite the losses through the cable.

In the example of FIG. 21, all light produced by the thin LED light sheet 146 (e.g., less than 1 mm) is directed toward the front of the conventional video fiber 150. A video camera 152 detects the image in front of the end of the fiber 150. The light sheet 146 may be a strip that is wrapped around the end of the fiber 150 multiple times to achieve the desired brightness, or the length of the light sheet and density of the LEDs may be selected to generated the required light using only one layer. Thin, flat conductors are affixed along the length of the fiber 150 to supply power to the LEDs. Any phosphor need only be located at the thin exit area of the light sheet, and the type of phosphor used (to select the overall emitted color) may be tailored to the particular use of the endoscope. The light sheet 146 may be replaceable for tailoring the color or brightness.

FIG. 20 is a cross-sectional view of the light sheet 146 over the video fiber 150. The light sheet 146, containing LEDs 14, is covered on all sides except the exit surface, by a thin reflective layer 154, such a metal layer. The fiber 150 may also be covered by a reflective layer if the LED light would otherwise couple into the sides of the fiber 150. The LEDs 14 may be side-emitting LEDs, having mirror electrodes, so all light is directed laterally, but this is not necessary since the reflective layers cause all light 156 to be emitted from the right edge of the light sheet 146.

Since the light sheet 146 may be only a single layer and be of any brightness, the light source for the endoscope adds no significant thickness to the endoscope. Further, there is less attenuation of light since the light source is near the end of the endoscope.

FIG. 22 illustrates another application of the edge-emitting light sheet 146 when affixed at the end of a dental tool 158 or other device where directed illumination is desirable. This avoids the need for an overhead light to illuminate the patient's mouth when using the dental tool 158.

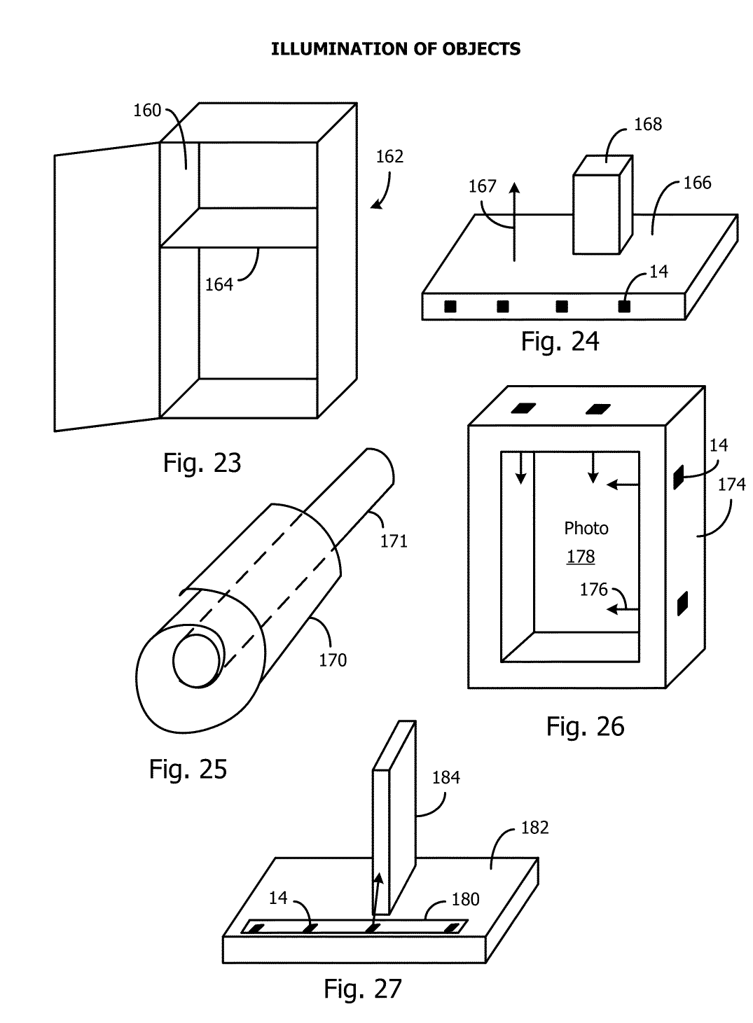

FIG. 23 illustrates an example of applying the LED light sheet 160 to the walls of a cabinet or refrigerator 162 to illuminate all objects in the structure without light blockage by the objects. A light sheet may also be affixed to the bottom of the shelf 164. In a conventional refrigerator, there are only a few small light sources. By using the flat light sheets, the surfaces may be easily cleaned and do not have to be replaced for the life of the refrigerator 162.

FIG. 24 illustrates how a strip of the LEDs 14 may be affixed to the edge of a transparent or translucent glass or plastic shelf 166 in the refrigerator 162 to allow the shelf to act as a lightguide. The top surface of the shelf 166 is textured to uniformly leak out the light 167 to illuminate objects 168 from the bottom up.

FIG. 25 illustrates an application where power is supplied to one edge of the light sheet 170 via a rod 171, and the light sheet 170 may be rolled up and unrolled to select the area of the light sheet 170. The light sheet 170 may be transparent so that, even when rolled up, all light generated is transmitted through the outer surface. This type of structure may be useful for transporting the light sheet 170 in a compact state.

FIG. 26 illustrates LED light strips having LEDs 14 affixed to the side or internal to a picture frame 174. The picture frame 174 may be a transparent or translucent plastic to act as a leaky lightguide. All LED light is directed inward due to a reflective layer on the outer surface of the light strips. The LED light 176 is then directed to the front of a conventional photo positioned in a recess 178 of the frame 174.

FIG. 27 illustrates the use of an LED light strip 180, containing LEDs 14, affixed to the front of a book shelf 182 for illuminating the fronts of books 184.

Many other applications of the light sheet structure for general illumination are envisioned, such as under-cabinet lighting, accent lighting of ceilings, using the flat light strips where ease of cleaning is important, etc.

Since the light sheets can be connected together to increase their effective light emission, various ways for interconnecting such modular light sheets are described below.

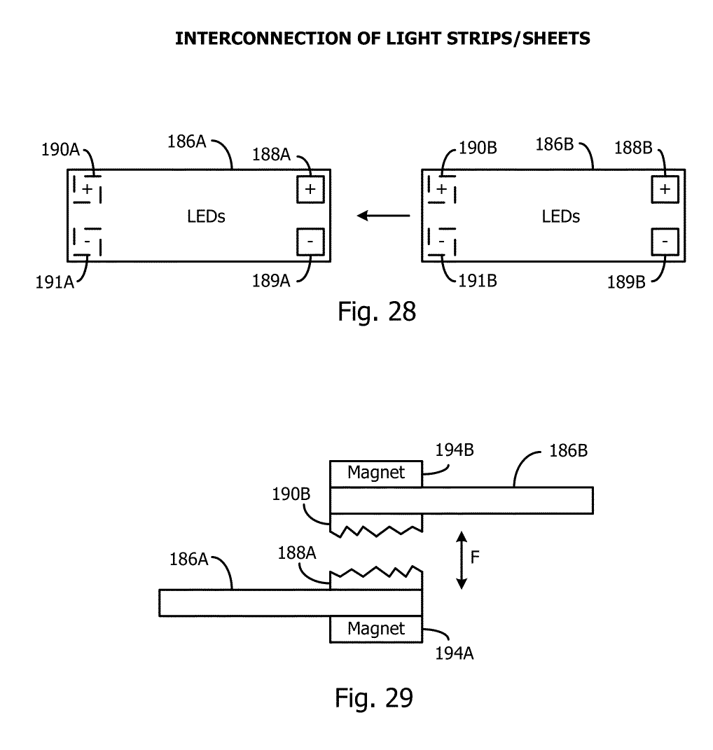

FIG. 28 illustrates identical light strips 186A and 186B containing printed LEDs sandwiched between two conductor layers, such as shown in FIG. 1. The two conductor layers terminate in front electrodes 188A, 189A, 188B, and 189B, and terminate in back electrodes 190A, 191A, 190B, and 191B. To connect the light strips together, the bottom electrodes 190B and 191B are positioned to overlap the top electrodes 188A and 189A. The terminals at either end of the connected light strips are then connected to a power supply. The electrodes may be provided with a weak conductive adhesive, or the technique of FIG. 29 may be used.

In FIG. 29, magnets 194A and 194B are printed opposite to each electrode 188A and 190B. When the electrodes 188A and 190B are brought together, the magnets 194A and 194B provide an attraction force F that ensure a good electrical connection. Further, the electrode surfaces are roughened to effectively increase the force per unit area to improve the electrical contact. The roughened surfaces also increase the frictional forces between the electrodes to withstand a greater lateral pulling force without disengagement.

The edges of the light sheets or strips may also form indentations and protrusions so the light sheets can fit together like puzzle pieces while also making good electrical connections. The connector locations prevent the light sheets from being connected with a reverse polarity. Snaps, clamps, or other mechanisms may also be used to create electrical connections while also providing a good mechanical interlock of the light sheets.

The connections shown cause all the LEDs in the strips to be connected in parallel. If an increased voltage drop is desired, some contacts may be reversed to create series connections between the strips. Each strip drops about 3 volts.

Due to thickness of the light sheet being typically thinner than cloth and resulting in the light sheet being highly flexible, the light sheet is particular suitable for lamination on clothing and textiles, or sewing the light sheet to the clothing or textiles. Applications of the light sheet for some clothing products are described below.

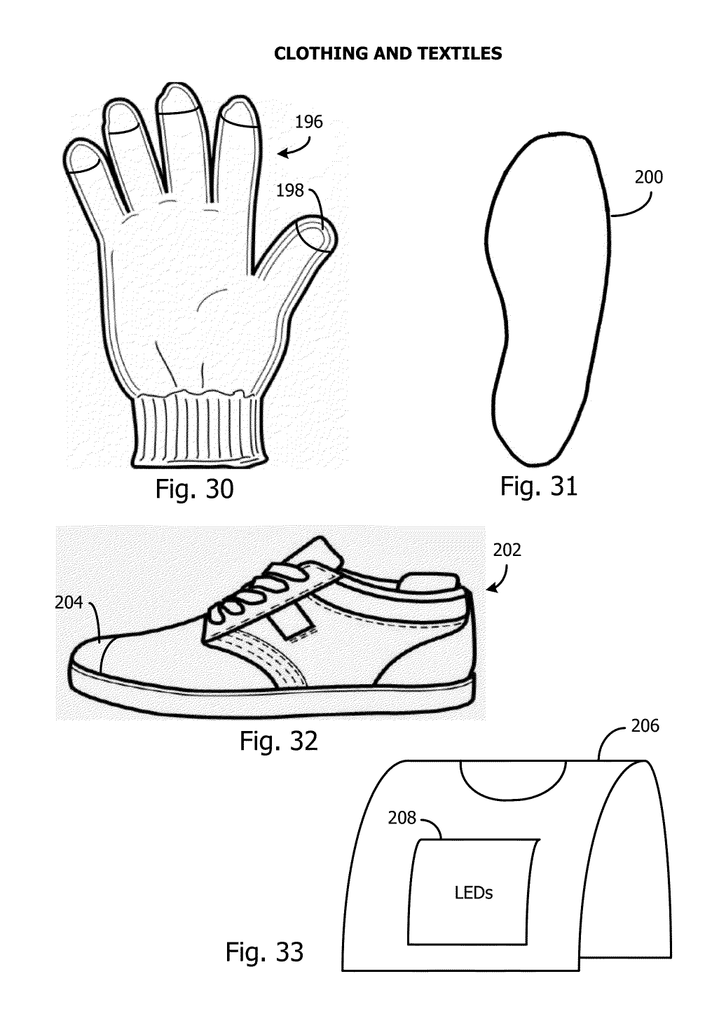

FIG. 30 illustrates a glove 196 equipped with LED light sheet pads 198 at the tips of the fingers and thumb. A small battery pack may be provided on the other side of the glove or external to it with a connector for the pads 198. The light will generally be directed to any task being performed. The glove 196 may be a surgical glove or other type of task glove.

FIG. 31 illustrates a UV LED light sheet shoe sole insert 200 that intermittently supplies UV light to the shoe for killing bacteria within the shoe either when wearing the shoe or while the shoe is off. Using a UV light sheet for other disinfection applications is envisioned, such as providing the UV light sheet in duct work for disinfecting air or for disinfecting water flowing in a pipe or in a fish tank. Such a UV light sheet may also be used as a grow light for plants.

FIG. 32 illustrates a white light LED light sheet 204 located at the tip of a shoe 202 for guidance and safety. A battery pack may be incorporated into the shoe, or a piezoelectric element or other charging mechanism may be used to charge a battery or capacitor for supplying power to the LEDs.

FIG. 33 illustrates a vest 206 or any type of clothing that is equipped with an LED light sheet patch 208 for either safety or as a way to illuminate a wide area around the wearer. In another embodiment, the LEDs, conductor layers, and other features of the light sheet are printed directly on cloth or other textile to obviate the need for a separate substrate. The cloth may be part of clothing or be sewn to clothing. For example, the light sheet may be printed directly on the vest 206 material.

The LED light strips may also be formed to be very narrow to allow weaving of the strips to form a flexible fabric.

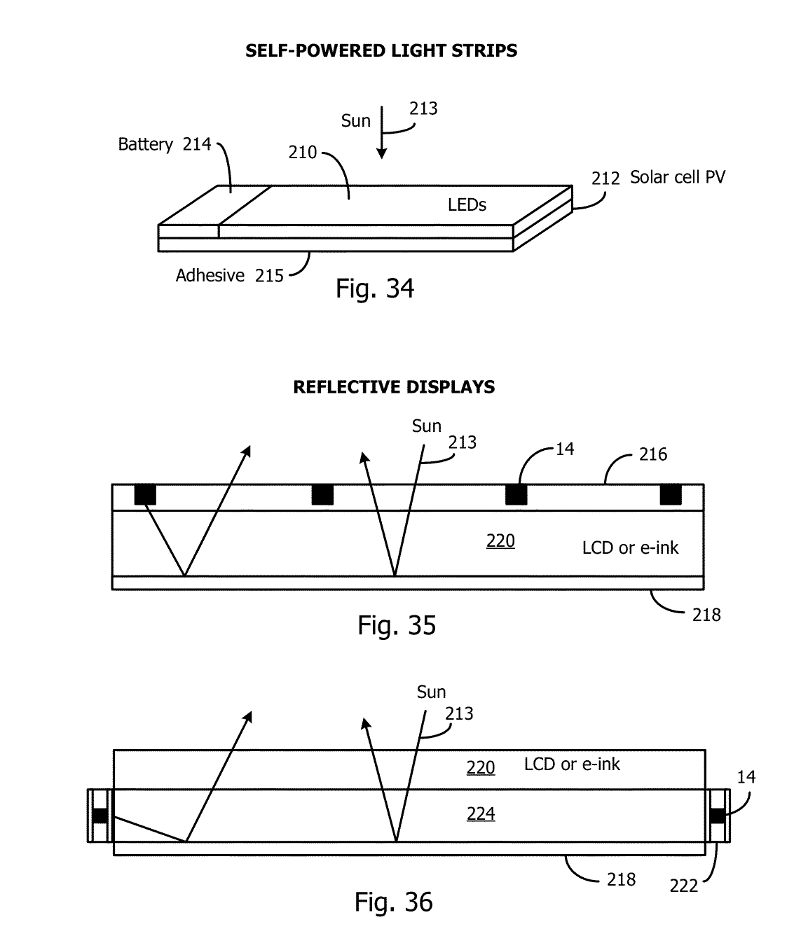

For certain outdoor applications where a source of power is not available or the replacement of batteries is not practical, the LED light sheet 210 of FIG. 34 may be connected to a photovoltaic cell 212 and a rechargeable battery 214. FIG. 34 illustrates a self-powered safety strip such as for walkways, emergency guides, identification of poles along roads, etc. The photovoltaic cell 212 comprises a thin layer of printed silicon diode beads sandwiched between two conductor layers, where the top conductor layer is transparent to allow the diodes to receive sunlight 213 and generate sufficient current during the day to fully recharge a printed lithium-ion battery 214. The LED light sheet 210 is transparent to allow the sunlight to reach the photovoltaic cell 212. Alternatively, the cell 212 may be laterally adjacent the light sheet 210. Since the light sheet 210, cell 212, and battery 214 all retain the same relative dimensions irrespective of the overall footprint, the same basic structure can have any size and operate in exactly the same way. An adhesive layer 215 on the bottom of the device allows the device to be affixed to any surface. The device may be on the order of about 1 mm thick.

The light sheet may also be formed to display a particular message, such as “caution” for road warnings and/or be formed to resemble traffic cones. By blinking the LEDs at intervals, the battery supply can last all night.

As shown in FIG. 35, since the basic LED light sheet can be transparent, the light sheet 216 can be used as a top layer in a reflective display. Areas of proximate red, green, and blue LEDs 14 may be used to create white light without the need of a phosphor layer. A reflective layer 218 is provided as a bottom layer. The light sheet 216 and reflective layer 218 sandwich a liquid crystal display (LCD) 220 effectively forming pixel light shutters. E-ink may be used instead. A conventional LCD controller controls the pixels to either block light or transmit light, or create grayscales, to display characters or animation. If sunlight is used, the sunlight passes through the transparent light sheet 216 and the “open” pixels and reflects off the reflective layer 218 to display the characters. If there is little ambient light, the LEDs 14 are turned on to emit light only in a downward direction to substitute for sunlight. The top electrode of the LEDs may be a mirror layer to block the LED light being directly emitted toward the viewer.

FIG. 36 illustrates another type of reflective display that enables the use of a translucent or opaque phosphor layer over the LED light strips 222 to create white light. When there is little ambient light, the LEDs 14 are turned on to inject white light from the sides of a transparent plastic waveguide 224. The top surface of the waveguide 224 is roughed to leak light uniformly out of the top surface to backlight the LCD 220 or e-ink layer. Sunlight can instead be used as described with respect to FIG. 35. The reflective displays of FIGS. 35 and 36 may be made about 1 mm thick. Better LED light mixing may be achieved with a thicker display.

Addressable LED displays are described below.

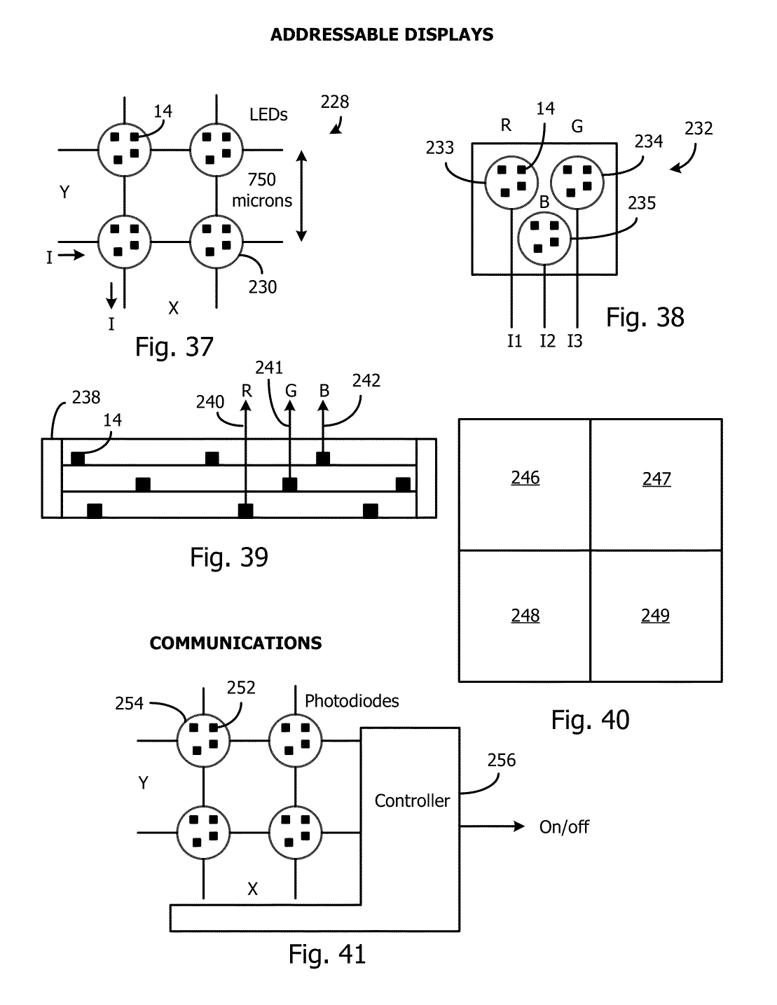

Although the printed microscopic LEDs 14 (FIG. 1) are randomly located, they are fairly uniformly distributed in the LED layer, and small pixel areas can be printed that have a very high probability of containing between 3-5 LEDs per pixel area. The pixel areas can be defined by screen printing or flexographic printing, among other possible methods. FIG. 37 illustrates a small portion of an addressable display 228 that has four pixels 230. Many more pixels are envisioned. Each pixel 230 has at least one LED 14 within it, and most likely has between 3-5 LEDs within it. For a monochromatic display, a YAG phosphor may be printed over each pixel 230 to create a well-defined white dot when the LEDs are illuminated. The LEDs 14 in each pixel 230 are sandwiched between two printed conductor layers, as described with respect to FIG. 1, where the top conductor layer is transparent. All LEDs in a column are printed over a column conductor strip (Y lines), and all LEDs in a row have their top electrodes contacted by a transparent row conductor strip (X lines). By selectively applying the anode voltage (e.g., 3 volts) and cathode voltage (e.g., ground) to the Y and X conductors, only the pixel at the intersection of energized conductors will be illuminated. At high scanning speeds, animation may be displayed. The pixels 230 may have a pitch of about 750 microns using screen printing.

If the current supplied to any pixel is fixed, an energized pixel provides the same brightness whether the pixel contains one LED or five LEDs. Therefore, such constant-current driving of pixels is ideally suited for a non-deterministic LED printing process.

The display can be bent into a partial cylinder to form a wrap-around immersion display.

FIG. 38 illustrates how a single pixel 232 can be formed of a red sub-pixel 233, a green sub-pixel 234, and a blue-sub-pixel 235, where the relative currents (I1, I2, I3) to each sub-pixel define the overall color for that pixel. The LEDs 14 may be red, green, and blue LEDs. Alternatively, all the LEDs may be blue LEDs, and the red-sub-pixel 233 has a red phosphor printed over it, and the green-sub-pixel 234 has a green phosphor printed over it.

The red, green, and blue sub-pixels may be laterally displaced, as shown in FIG. 38, or the red, green, and blue sub-pixels may be vertically displaced as shown in FIG. 39. In FIG. 39, three LED layers are shown. Each layer outputs either red light, green light, or blue light using appropriate type printed microscopic LEDs. The LED layers are either laminated together, or the red, green, and blue LEDs may be successively printed, with a transparent conductor layer therebetween. In FIG. 39, an opaque wall 238 surrounds each pixel area to prevent lateral light creating noise in other pixels. The LEDs in each of the three layers are independently energized with a current to create the desired mixture of colors for the pixel. An X-Y addressing technique may be used for each color LED in each pixel. The RGB light (rays 240, 241, and 242) blends very well and there will be statistically little or no overlap of LEDs due to the microscopic size of each LED and the random distribution of LEDs. Any statistically calculated overlap of LEDs, creating some light blockage, may be compensated for by adjusting the density of LEDs in each layer.

A thin, flexible and light bracelet or other item of clothing can easily be created that displays a programmable animation or any other display.

FIG. 40 illustrates how a large addressable or static color display may be created by identical interconnected light sheets 246-249. The proper alignment of the light sheets 246-249 couples the column and row conductors together and aligns the pixels. Suitable connectors may be provided along the four edges of the light sheets 246-249. An adhesive or other structure may be used to affix the light sheets 246-249 together. There will be no visible interfaces, since the light sheets 246-249 are so thin, and the pixels may extend to the edges of the light sheets 246-249.

FIG. 41 illustrates how the basic structure of the light sheets can be used to detect light rather than generate light. Instead of printing vertical LEDs, vertical photodiodes 252 are printed and properly biased to conduct an analog current proportional to the light impinging on the photodiodes. This technique can be used to create an extremely inexpensive and thin camera for certain purposes, such as for roughly detecting images for user biometrics and for light or motion sensing applications. An optional lens may be positioned over the photodiode array. If imaging is desired, groups of the photodiodes 252 are printed in an array of independently sensed pixels 254. The photodiodes 252 are connected in parallel in each separate pixel 254, where the top conductor layer is transparent. A controller 256 scans the X and Y conductors to detect and process the analog current for each pixel 254 to determine the image or to control other circuits.

The LED light sheet may also be used for entertainment purposes such as described below.

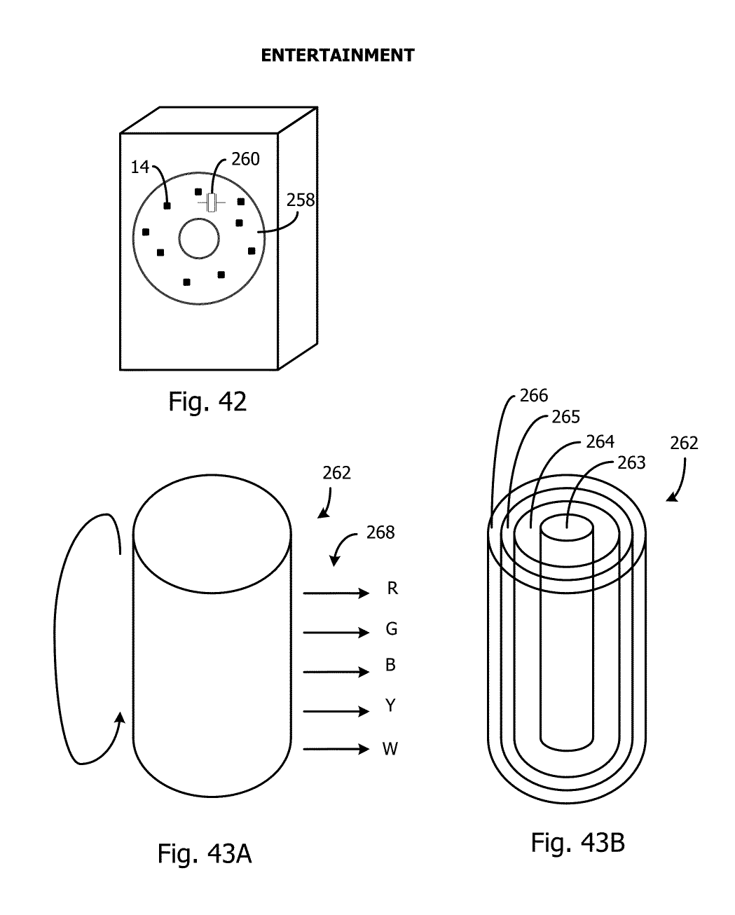

In FIG. 42, the cone of a woofer 258 in a speaker is laminated with an LED light sheet containing the LEDs 14. The light sheet is bent to form a cone. Red, green, and blue LEDs may be used to create a mixture of colors as described above. A piezoelectric element 260 generates a voltage having a magnitude and frequency that is related to the magnitude and frequency of the movement of the cone. The electrical signal may be used to directly drive the LEDs 14, or the signal may be processed and amplified to drive the LEDs 14 to create light patterns with varying colors and brightness that correspond to the music being played.

FIG. 43A is an external view of another light entertainment system 262, and FIG. 43B is a semi-transparent view of the system 262. A central column 263 of the system 262 is formed by a single light sheet containing blue LEDs, where the light sheet is rolled up to form a cylinder. All the blue light is emitted outward. As shown in FIG. 43B, there are three concentric transparent cylinders 264, 265, and 266 surrounding the central column 263, where the cylinder 264 contains a liquid with red phosphor particles, the cylinder 265 contains a liquid with green phosphor particles, and the cylinder 266 contains a liquid with any other type of phosphor, such as orange phosphor, yellow phosphor, or a combination of phosphors that create white light. Other types of phosphors may be contained in the various cylinders. The viscosity of the liquid is such that the phosphor particles slowly sink through the liquid when the system is turned upside down. The downward velocity of the various phosphor particles may be different for each cylinder so the colors change with time. Various color light rays 268 are shown in FIG. 43A. The system 262 may be inexpensively formed using transparent, flexible bent plastic sheets that are affixed between top and bottom circular plates. Reflective particles may also be included in the liquid. The phosphor particles may also be more randomly agitated by shaking the system 262 or by a heat source. The system 262 may be any size.

In another embodiment, only one cylinder surrounds the central column 263 and different types of phosphor are incorporated in the same liquid in the cylinder. The different phosphors sink at different rates or create random distribution patterns to change the overall color with time.

The above-described applications of the basic light sheet structure of FIG. 1 are just a few of the possible applications, and additional suitable applications will arise as lighting problems are identified that need to be remedied.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. An illumination system for an automobile comprising:
a translucent ceiling material covering a ceiling area of the automobile;
at least one layer of light emitting diodes (LEDs) provided over a flexible substrate; and
a first conductor layer and a second conductor layer sandwiching the LEDs to supply power to the LEDs, at least the first conductor layer allowing light to pass through,
the first conductor layer, the second conductor layer, and the substrate comprising a flexible light sheet,
wherein the light sheet is positioned behind at least a portion of the ceiling material to backlight the ceiling material, and
wherein light from the light sheet, when the LEDs are illuminated, passes through the ceiling material to illuminate an interior of the automobile.

2. The system of claim 1 wherein the ceiling material has a first color that contributes to an overall color of light illuminating the interior of the automobile, wherein one or more color components of a light emission from the light sheet are adjusted to account for the first color contributed by the ceiling material to substantially achieve a target color illuminating the interior of the automobile.

3. The system of claim 1 further comprising a plurality of separately controllable light sheets backlighting different areas of the ceiling material to allow selected portions of the interior of the automobile to be illuminated.

4. The system of claim 1 further comprising a controller in the automobile for changing a color emission of the light sheet.

5. The system of claim 1 wherein the LEDs comprise multi-color LEDs.

6. The system of claim 1 wherein the light sheet comprises a phosphor layer.

7. The system of claim 1 wherein the light sheet backlights over 50% of the ceiling area.

8. The system of claim 1 further comprising a plurality of separately controllable light sheets backlighting different areas of the ceiling material, wherein the plurality of light sheets backlights over 50% of the ceiling area.

9. The system of claim 1 wherein the ceiling material is woven to allow light from the light sheet to pass directly through openings in the weave.

10. The system of claim 9 wherein a weave density is selected to allow a certain amount of light to pass directly through the openings in the weave to achieve a target illumination of the interior of the automobile.

11. The system of claim 1 wherein the ceiling material includes an array of holes to allow light from the light sheet to pass directly through the holes.

12. The system of claim 11 wherein a hole density is selected to allow a certain amount of light to pass directly through the holes to achieve a target illumination of the interior of the automobile.

13. The system of claim 1 wherein the light sheet cannot be seen through the ceiling material in its off-state.

14. The system of claim 1 further comprising a plurality of light sheets backlighting the ceiling material, where each light sheet has a voltage drop, wherein the light sheets are connected in series to achieve an overall voltage drop of substantially a battery voltage of the automobile.

15. The system of claim 1 wherein the LEDs are microscopic inorganic LEDs printed on the substrate.

16. The system of claim 1 further comprising one or more additional light sheets positioned in a hood of the automobile for illuminating an engine of the automobile when the hood is opened.

17. The system of claim 1 further comprising one or more additional light sheets positioned in doors of the automobile for illuminating an area around the automobile when the doors are opened.

18. The system of claim 1 further comprising one or more additional light sheets affixed to a visor of the automobile.

19. The system of claim 1 further comprising one or more additional light sheets affixed to a back of a front seat of the automobile.

20. The system of claim 1 further comprising one or more additional light sheets affixed to a floor of the automobile.

21. The system of claim 1 further comprising one or more additional light sheets affixed inside a seat belt receptacle of the automobile for identifying an opening for a seat belt buckle.
